(19) United States
(12) Patent Application Publication
(10) Pub. No.: US 2024/0328022 A1
(43) Pub. Date: Oct. 3, 2024

(54) ELECTROCHEMICAL METALLURGICAL PROCESS FOR EXTRACTING METALS AND SULFUR FROM METALLIC SULFIDES

(71) Applicant: Kunming University of Science and Technology, Kunming (CN)

(72) Inventors: Jia Yang, Kunming (CN); Kanwen Hou, Kunming (CN); baohong Wei, Kunming (CN); Jiancheng Qian, Kunming (CN); Baoqiang Xu, Kunming (CN); Bin Yang, Kunming (CN); Dachun Liu, Kunming (CN); Wenlong Jiang, Kunming (CN); Yong Deng, Kunming (CN); Yifu Li, Kunming (CN); Yang Tian, Kunming (CN); Heng Xiong, Kunming (CN); Fei Wang, Kunming (CN); Qingchun Yu, Kunming (CN); Hongwei Yang, Kunming (CN)

(21) Appl. No.: 18/743,648

(22) Filed: Jun. 14, 2024

Related U.S. Application Data
(63) Continuation of application No. PCT/CN2022/142708, filed on Dec. 28, 2022.

(30) Foreign Application Priority Data
Sep. 2, 2022 (CN) 2022110724019

(51) Int. Cl. C25C 7/02; C25C 1/02; C25C 1/10; C25C 1/12; C25C 1/14; C25C 1/16; C25C 1/18; C25C 1/22

(52) U.S. Cl. CPC C25C 7/02; C25C 1/02; C25C 1/10; C25C 1/12; C25C 1/14; C25C 1/16; C25C 1/18; C25C 1/22

(57) ABSTRACT

This invention presents an electrochemical metallurgical technique for extracting metals and sulfur from metal sulfides, offering an adjustable composition and mechanical properties during electrode preparation. The metal sulfide anode, submerged in an electrolyte with a cathode made of materials like titanium, copper, stainless steel, lead, zinc, aluminum or graphite, undergoes electrolysis. This process oxidizes sulfur in the metal sulfide to the anode and releases metal ions into the electrolyte, where they're reduced at the cathode. The method yields metal at the cathode and sulfur at the anode, with minimal environmental impact, low investment, and straightforward process.

### CROSS REFERENCE TO RELATED APPLICATION

This application claims the priority of Chinese Patent Application No. CN202211072401.9, entitled “An electrochemical metallurgical process for extracting metals and sulfur from metallic sulfides”, filed on Sep. 2, 2022, the disclosure of which is incorporated herein by reference in its entirety.

### BACKGROUND OF THE INVENTION

### 1. Field of the Invention

The electrochemical metallurgical method described in this invention aims to extract metals and sulfur from metal sulfides, within the technical domain of the metallurgical chemical industry.

### 2. Description of Related Art

Sulphides are the main source of extraction of most metals and have important economic value. More than 300 kinds of sulfides have been found in nature. In modern metallurgy, the treatment method of metal sulfide is mostly high-temperature chemical process. However, the method of extracting metals from metal sulfides is more complicated than that of oxidized ores, mainly because sulfides cannot directly reduce metals with carbon. There are three main ways to extract metal from metal sulfide: first, through oxidation roasting, and then through reduction or other ways to get metal or alloy; The second is through matte smelting, and then through blowing, refining and other ways to get metal; The third is through sulfation roasting, and then through leaching, electrodeposition and other ways to get metal.

Oxidation roasting of metal sulfides involves heating the sulfide below its melting point to facilitate oxidation, converting the sulfide into a metal oxide. The primary objective of this process is to eliminate some or all of the sulfur present in the metal sulfide. During roasting, sulfur escapes as sulfur dioxide flue gas. The resulting metal oxides can be further processed through various methods. They may be reduced back to metals or alloys using reducing agents, or they can be extracted through leaching, electrodeposition, or similar techniques. For instance, in lead metallurgy, lead sulfide and other sulfides present in lead sulfide concentrate are subjected to high-temperature, oxidizing conditions to produce lead-containing oxides. These oxides are then reduced using carbon to obtain crude lead, which is subsequently refined. Similarly, in zinc metallurgy, the aim is to remove sulfur from zinc sulfide concentrate through oxidation roasting, thereby converting zinc sulfide into zinc oxide. Following this, zinc is extracted through sulfuric acid leaching and subsequent electrodeposition. Oxidation roasting finds widespread application in the extraction processes of various metals, including antimony, mercury, and others.

Metal sulfides, including copper sulfide, are commonly found alongside iron sulfides and are often extracted using the matte smelting process. Matte smelting operates on the principle of utilizing the higher affinity of the main metal and sulfur compared to iron or other impurity metals. Additionally, iron exhibits a greater affinity to oxygen compared to the main metal.

During matte smelting, conducted under high temperature and controlled oxidation conditions, iron is oxidized to ferrous oxide. Subsequently, gangue and flux materials are added to facilitate slag removal, resulting in the fusion of metal and sulfur, or multiple metal sulfides, into matte. Matte smelting is conducive to retaining sulfur in the matte, as it allows only a small portion to convert to sulfur dioxide due to controlled oxidation atmosphere. For example, copper matte is a product of this process. Further extraction of metal from matte involves processes such as blowing and refining. In the blowing process, sulfur is converted to sulfur dioxide. Matte smelting is also employed in the extraction of metals such as lead, molybdenum, antimony, bismuth, and cobalt. This method is favored for its ability to efficiently extract metals while retaining sulfur within the matte, ensuring effective utilization of resources and minimizing environmental impact.

Sulfation roasting of metal sulfides exploits the variations in decomposition temperature among sulfates, as well as the boiling point of the compounds and their water solubility. By carefully controlling the temperature, metal compounds can be converted into sulfates or into the gas phase. Some sulfates may decompose into insoluble oxides, allowing for the extraction of metal through leaching or directed separation. For instance, in the pyrometallurgy of copper and cobalt concentrate, the objective is to convert copper, cobalt, and other valuable metals into water-soluble sulfate compounds under precise control of furnace atmosphere and temperature. This process results in the conversion of sulfur into sulfur dioxide and iron into iron trioxide to the greatest extent possible. Copper sulfate, cobalt sulfate, and similar compounds can then be obtained through methods such as electrodeposition to extract the metals or alloys. Sulfation roasting is also utilized in the extraction processes of metals such as zinc, nickel, vanadium, and others. This method allows for efficient extraction of metals by harnessing the chemical properties of sulfates and their derivatives.

### SUMMARY OF THE INVENTION

In summary, the treatment of metal sulfides results in the oxidation of most sulfur to sulfur dioxide. Sulfur dioxide emissions can pose significant atmospheric pollution, necessitating the installation of flue gas desulfurization facilities in metallurgical enterprises. While much of the recovered sulfur dioxide is utilized in the production of sulfuric acid, transporting sulfuric acid presents logistical challenges and limitations on transportation distance, making long-term storage impractical. Furthermore, during smelting processes for metals like lead and antimony, carbon dioxide is also generated, which undermines efforts to reduce carbon emissions and achieve carbon reduction goals. These environmental concerns highlight the importance of implementing sustainable practices and developing alternative solutions to mitigate the impact of metallurgical processes on the environment.

The invention introduces an electrochemical metallurgical method tailored for treating metal sulfides, facilitating the extraction of both metal and sulfur from these compounds. The method involves immersing a metal sulfide electrode into an electrolyte for electrolysis, resulting in the production of cathodic metal and anodic sulfur. This process enables the extraction of both metal and sulfur while concurrently mitigating the emission of harmful gases like sulfur dioxide typically generated during conventional smelting processes. Consequently, it alleviates environmental pressures, reduces the necessity for importing sulfur, and exhibits traits such as a streamlined process, minimal investment requirements, and absence of sulfur dioxide pollution.

Embodiment 1: An electrochemical metallurgical method for extracting metals and sulfur from metal sulfides, the steps are as follows:
(1) The sodium sulfide anode is prepared by thermal spraying method, in which sodium sulfide (Na₂S) is the product of a chemical plant in Shanghai, and its sodium sulfide content is ≥60%; The particle size of sodium sulfide is 80 μm, the heat source is plasma arc heating, and the pressure of nitrogen is 10 MPa; The base plate is titanium, the longitudinal section is triangular, the longitudinal section area is 500 cm², the thickness is 1.5 mm; There are 5 mm sodium sulfide on both sides of the base plate;
The cathode material is stainless steel, the longitudinal section shape is triangular, the longitudinal section area is 600 cm², the thickness is 2 mm;
(2) Insert 300 anode pieces, 301 cathode pieces, anode and cathode intervals into the closed electrolytic cell;
The electrolyte is 80% acetonitrile and 20% tetrahydrofuran as the solvent, the electrolyte is 50 g/L sodium tetrafluoroborate and 12 g/L sodium chloride, the oxidant is 10 g/L hydrogen peroxide and 20 g/L sodium perchlorate, no additives; Control the distance between the electrode is 20 mm, the tank voltage is 1.5V, the current density is 300 A/m², the electrolyte temperature is 30° C., the cycle speed is 5 L/min, and the electrolysis is energized; When the residual electrode rate of the anode is about 10%, stop the power, take out the anode and cathode, and peel the anode and cathode products by artificial method; The product enters the subsequent process, and the residue returns to the anode preparation process.

Embodiment 2: An electrochemical metallurgical process for extracting metals and sulfur from metal sulfides, the steps are as follows:
(1) Preparation of the stannous sulfide anode by vacuum evaporation process: Stannous sulfide (SnS) is the product of a chemical plant in Hubei province, the content of stannous sulfide is ≥95%, the particle size of stannous sulfide is 100 μm, the heating method is resistance heating, the vacuum degree is 10⁻³ Pa, the base plate is stainless steel, the longitudinal section is square, the longitudinal section area is 180 cm², the thickness is 1 mm, A total of 10 mm thick tin sulfide on both sides of the base plate;
The cathode material is stainless steel, the longitudinal section shape is square, the longitudinal section area is 200 cm², the thickness is 1.5 mm;
(2) Take 240 pieces of anode, 241 pieces of cathode, anode and cathode interval into the electrolyte;
The electrolyte is water as solvent, the electrolyte is 55 g/L stanyous sulfate, 50 g/L sulfuric acid, the oxidizer is 20 g/L ferric chloride, the additive is 25 mg/L cresol sulfonic acid, the control distance between the electrode is 22 mm, the tank voltage is 2.5V, the current density is 220 A/m², the electrolyte temperature is 50° C., and the cycle speed is 15 L/min. Electrified electrolysis. When the residual rate of the anode is about 5%, stop electrolysis; Take out the anode and cathode, empty the electrolyte in the electrolytic cell, and peel the anode and cathode products by mechanical method; The product enters the subsequent process, and the residual electrode returns to the anode preparation process.

Embodiment 3: An electrochemical metallurgical process for extracting metals and sulfur from metal sulfides, the steps are as follows:
(1) Aluminum sulfide anodes are prepared by magnetron sputtering: Aluminum sulfide (Al₂S₃) is the product of a chemical plant in Hubei province, the content of aluminum sulfide is ≥95%, the target is selected aluminum sulfide target, the vacuum degree after filling argon is 1 Pa, the base plate is titanium alloy, the longitudinal section is square, the longitudinal section area is 800 cm², the thickness is 2 mm, and the two sides of the base plate have a total of 3 mm thick aluminum sulfide;
The cathode material is stainless steel, the longitudinal section shape is square, the longitudinal section area is 0.1 m², the thickness is 2.5 mm;
(2) Take 350 pieces of anode, 351 pieces of cathode, anode and cathode spacing into the electrolyte,
The electrolyte is 80% methanol and 20% acetonitrile as the solvent, the electrolyte is 60 g/L aluminum chloride and 10 g/L ammonium chloride, the oxidant is 20 g/L hydrogen peroxide, no additives; Control the distance between the electrode is 18 mm, the tank voltage is 1.9V, the current density is 280 A/m², the electrolyte temperature is 25° C., the cycle speed is 7 L/min, electrolysis, when the anode residue rate is about 10%, stop the power, take out the anode and cathode, the product is removed by artificial method, the product enters the subsequent process, the residue returns to the anode preparation process.

Embodiment 4: An electrochemical metallurgical method for extracting metals and sulfur from metal sulfides, the specific steps are as follows:
(1) Preparation of antimony sulfide anode by chemical vapor deposition: antimony powder is the product of an antimony smelter in Shandong province, and its antimony content is ≥90%; Sulfur powder is the product of a chemical plant in Yunnan, its sulfur content is ≥90%, the sulfur powder is placed in the low temperature zone of the evaporation vessel, antimony powder is placed in the high temperature zone, argon is filled in the equipment, heating the sulfur powder volatilization, and antimony powder synthesis reaction to generate antimony sulfide, control the temperature to volatilize antimony sulfide, and deposited on the substrate; The substrate material is lead alloy, the longitudinal section is round, the longitudinal section area is 200 cm², the thickness is 1 mm, the two sides of the substrate a total of 6 mm thick antimony sulfide;
The cathode material is titanium, the longitudinal section shape is round, the longitudinal section area is 240 cm², the thickness is 1.5 mm;
(2) Take 270 pieces of anode, 271 pieces of cathode, anode and cathode spacing into the electrolyte;
Electrolyte is water as solvent, electrolyte is 60 g/L sodium sulfide, 30 g/L sodium hydroxide, 15 g/L sodium sulfide, oxidizer is 20 g/L sodium hypochlorite, no additives, control the distance between the electrode is 25 mm, tank voltage is 2.7V, current density is 350 A/m², electrolyte temperature is 60° C., cycle speed is 10 L/min. In the electrolytic process, ultrasonic method is used to peel the anode surface sulfur, electrified electrolysis; When the anode residue rate is about 15%, stop the power, take out the anode and cathode, empty the electrolyte in the electrolytic cell, peel the cathode product by manual method, and enter the electrolytic cell to recover the anode product; The product enters the subsequent process, and the residual electrode returns to the anode preparation process.

Embodiment 5: An electrochemical metallurgical process for extracting metals and sulfur from metal sulfides, the steps are as follows:

The chemical composition of the bismuthite concentrate in the present embodiment, which is obtained from a bismuth smelter in Hunan, is shown in Table 1:

Table 1 Chemical composition mass fraction (%) of bismuth sulfide concentrate from a bismuth smelter in Hunan
(1) The bismuth concentrate was broken, and mixed with stainless steel fiber of 0.5% of the concentrate mass, and put into a vacuum induction furnace to heat and melt, and cast into a anode plate by sand casting method, with the size of 1000 mm long, 550 mm wide and 55 mm thick;
The cathode material is copper, the longitudinal section shape is square, the longitudinal section area is 0.55 m², the thickness is 5 mm;
(2) Take 40 anodes and 41 cathodes and insert them into the electrolyte.

Electrolyte with water as solvent, electrolyte 180 g/L bismuth chloride, 150 g/L hydrochloric acid, oxidant 25 g/L iron sulfate, no additives; Control the distance between the electrode is 120 mm, the tank voltage is 3.1V, the current density is 200 A/m², the electrolyte temperature is 45° C., the cycle speed is 10 L/min, and the electrolysis is powered on. When the anode residue rate is about 10%, the power is stopped, the anode and cathode are removed, and the anode and cathode products are stripped by ultrasonic method. The product enters the subsequent process, and the residual electrode returns to the anode preparation process.

Embodiment 6: An electrochemical metallurgical process for extracting metals and sulfur from metal sulfides, the steps are as follows:
(1) The anode is prepared by centrifugal forming method: the bismuth concentrate is broken to the particle size of 100 μm, the forming agent is selected sulfur powder, the carbon fiber of 1% of the mass of the concentrate is added, mixed evenly, loaded into the mold of the centrifuge, the speed is adjusted to 3500 r/min, the size of the green is 850 mm long, 650 mm wide and 60 mm thick; The green billet into the sintering process, in the nitrogen atmosphere, adjust the sintering temperature to 750° C., heat preservation 2 h;
The cathode material is titanium, the longitudinal section shape is square, the longitudinal section area is 0.6 m², the thickness is 6 mm;
(2) Take 35 pieces of anode, 36 pieces of cathode, anode and cathode spacing into the electrolyte;
The electrolyte is water as the solvent, the electrolyte is 240 g/L bismuth silicofluorate, 150 g/L silicofluoric acid and 30 g/L sodium chloride, the oxidant is 20 g/L hydrogen peroxide, no additives; The control distance between the electrode is 75 mm, the tank voltage is 3.0V, the current density is 150 A/², the electrolyte temperature is 40° C., the cycle speed is 8 L/min, and the electrolysis is energized; When the residual electrode rate of the anode is about 8%, stop the power, take out the anode and cathode, and peel the anode and cathode products by mechanical method; The product enters the subsequent process, and the residue returns to the anode preparation process.

Embodiment 7: An electrochemical metallurgical process for extracting metals and sulfur from metal sulfides, the steps are as follows:
The present embodiment's manganese sulphide concentrate is the raw material of a manganese smelter in Yunnan, and its chemical composition is shown in Table 2:
Table 2 Chemical composition Mass fraction (%) of manganese sulfide ore concentrate from a manganese smelter in Yunnan
(1) The manganese sulfide concentrate was broken, and mixed with carbon fiber of 0.8% of the concentrate mass, which was heated and melted in vacuum arc furnace, and the anode was prepared by sand casting method. The size of the prepared anode was 1200 mm long, 500 mm wide and 40 mm thick;
The cathode material is titanium, the longitudinal section shape is square, the longitudinal section area is 0.6 m², the thickness is 6 mm;
(2) Take 45 pieces of anode, 46 pieces of cathode, anode and cathode spacing into the electrolyte,
Electrolyte with water as solvent, electrolyte is 40 g/L manganese chloride, 10 g/L hydrochloric acid, 30 g/L ammonium chloride, oxidizer is 40 g/L potassium permanganate, no additives; Control the distance between the electrode is 75 mm, the tank voltage is 2.3V, the current density is 350 A/m², the electrolyte temperature is 50° C., the cycle speed is 20 L/min, and the electrolysis is energized; In the electrolytic process, ultrasonic method is used to peel the anode surface sulfur, when the anode residual rate is about 13%, stop the power; Take out the anode and cathode, empty the electrolyte in the electrolytic cell, peel the cathode product by mechanical method, and recover the anode product manually; The product enters the subsequent process, and the residual electrode returns to the anode preparation process.

Embodiment 8: An electrochemical metallurgical process for extracting metals and sulfur from metal sulfides, the steps are as follows:
(1) Anode preparation by press method: The sulfur manganese ore concentrate is broken to the particle size of 120 μm, the forming agent is selected sulfur powder, add the concentrate quality of 1% stainless steel fiber, mixed evenly, into the mold of the press, pressing forming under the pressure of 25 MPa, pressing speed is 12 mm/s, holding pressure time is 1.5 h, the size of the green is 1000 mm long, 600 mm wide, 50 mm thick; The green billet into the sintering process, in the nitrogen atmosphere, adjust the sintering temperature to 1200° C., hold 1.5 h;
The cathode material is stainless steel, the longitudinal section shape is square, the longitudinal section area is 0.6 m², the thickness is 4 mm;
(2) Take 40 pieces of anode, 41 pieces of cathode, anode and cathode spacing into the electrolyte,
The electrolyte is water as the solvent, the electrolyte is 45 g/L manganese chloride, 80 g/L ammonium sulfate, 10 g/L hydrochloric acid, the oxidant is 20 g/L hydrogen peroxide, no additives; Control the distance between the electrode is 70 mm, the tank voltage is 2.0V, the current density is 400 A/m², the electrolyte temperature is 45° C., the cycle speed is 21 L/min, the power electrolysis, when the anode residue rate is about 15%, stop the power, take out the anode and cathode, and peel the anode and cathode products by ultrasonic method; The product enters the subsequent process, and the residual electrode returns to the anode preparation process.

Embodiment 9: An electrochemical metallurgical process for extracting metals and sulfur from metal sulfides, the steps are as follows:
The present embodiment sphalerite concentrate is the raw material of a zinc smelter in Yunnan, and its chemical composition is shown in Table 3:
Table 3 Chemical composition Mass fraction (%) of sphalerite concentrate of a zinc smelter in Yunnan
(1) The anode was prepared by hot plating method: sphalerite concentrate, 15% copper, 8% sulfur and 10% tin of the concentrate were added to the vacuum induction furnace and melted by heating. The base plate was lead alloy, the longitudinal cross-section was palisade, the longitudinal cross-section area was 0.25 m², the thickness was 3 mm, and the surface of the base plate was coated with a layer of carbon fiber and then inserted into the melt for hot plating; After hot plating, there are 15 mm thick sphalerite concentrate on both sides of the substrate;
The cathode material is aluminum, the longitudinal section shape is square, the longitudinal section area is 0.25 m², the thickness is 3 mm;
(2) Take 150 pieces of anode, 151 pieces of cathode, anode and cathode spacing into the electrolyte,
The electrolyte is water as solvent, the electrolyte is 180 g/L zinc sulfate, 120 g/L sulfuric acid, the oxidant is 40 g/L ferric chloride, the additive is 10 mg/L gelatin, the control distance between the electrode is 30 mm, the tank voltage is 2.7V, the current density is 450 A/m², the electrolyte temperature is 45° C., and the cycle speed is 22 L/min. Power electrolysis, when the anode residue rate is about 8%, stop the power, take out the anode and cathode, and peel the anode and cathode products by mechanical method; The product enters the subsequent process, and the residue returns to the anode preparation process.

Embodiment 10: An electrochemical metallurgical process for extracting metals and sulfur from metal sulfides, the steps are as follows:
(1) The preparation of anode by centrifugal forming method: the sphalerite concentrate is broken to the particle size of 90 μm, the forming agent is selected graphite powder, and then the copper of 10% of the concentrate mass is mixed evenly, which is put into the mold of the centrifuge, and the speed is adjusted to 3300 r/min; The size of the green is 820 mm long, 680 mm wide, 60 mm thick; The green billet is sent to the sintering process, under the nitrogen atmosphere, the sintering temperature is adjusted to 1150° C., and the heat preservation is 1.8 h;
The cathode material is stainless steel, the longitudinal section shape is square, the longitudinal section area is 0.6 m², the thickness is 3 mm;
(2) Take 35 pieces of anode, 36 pieces of cathode, anode and cathode spacing into the electrolyte;
The electrolyte is water as the solvent, the electrolyte is 100 g/L zinc chloride, 80 g/L hydrochloric acid, the oxidant is 35 g/L potassium permanganate, and the additive is 15 mg/L bone glue; Control the distance between the electrode is 75 mm, the tank voltage is 2.5V, the current density is 350 A/m², the electrolyte temperature is 50° C., the cycle speed is 25 L/min, and the electrolysis is energized; When the anode residual rate is about 10%, stop the power, in the electrolytic process using mechanical stripping anode products, after the end of electrolysis, take out anode and cathode, through the ultrasonic stripping cathode products; The product enters the subsequent process, and the residual electrode returns to the anode preparation process.

Embodiment 11: An electrochemical metallurgical process for extracting metals and sulfur from metal sulfides, the steps are as follows:
The galena concentrate of the present embodiment is the raw material of a lead smelter in Yunnan, and its chemical composition is shown in Table 4:
Table 4 Chemical composition Mass fraction (%) of galena concentrate from a lead smelter in Yunnan.
(1) The galena concentrate was heated and melted in a vacuum induction furnace, and the anode was prepared by solid casting method. The dimensions of the anode after preparation were 910 mm long, 590 mm wide and 55 mm thick;
The cathode material is lead, the longitudinal section shape is square, the longitudinal section area is 0.55 m², the thickness is 3 mm;
(2) Take 40 anodes and 41 cathodes and insert them into the electrolyte;
Electrolyte with water as solvent, electrolyte is 80 g/L lead chloride, 25 g/L hydrochloric acid, oxidant is 30 g/L ferric chloride, additive is 10 mg/L sodium lignosulfonate; Control the distance between the electrode is 80 mm, the tank voltage is 2.9V, the current density is 200 A/m², the electrolyte temperature is 50° C., the cycle speed is 20 L/min, and the electrolysis is energized; When the residual electrode rate of the anode is about 20%, stop the power, take out the anode and cathode, and recover the anode and cathode products by mechanical method; The product enters the subsequent process, and the residue returns to the anode preparation process.

Embodiment 12: An electrochemical metallurgical process for extracting metals and sulfur from metal sulfides, the steps are as follows:
(1) Anode preparation by press process: The galenite concentrate is broken to the particle size of 150 μm, the forming agent is sulfur powder, mixed evenly, into the mold of the press, pressing forming under the pressure of 20 MPa, pressing speed is 10 mm/s, pressure holding time is 2 h, the size of the green is 800 mm long, 700 mm wide, 60 mm thick, the green is sent into the sintering process, in the nitrogen atmosphere, Adjust the sintering temperature to 800° C., heat preservation 2 h;
The cathode material is titanium, the longitudinal section shape is square, the longitudinal section area is 0.6 m², the thickness is 3.5 mm;
(2) Take 35 pieces of anode, 36 pieces of cathode, anode and cathode spacing into the electrolyte,
The electrolyte was water as solvent, the electrolyte was 100 g/L lead fluorosilicate, 60 g/L silicofluoric acid, 20 g/L sodium chloride, the oxidant was 0.15 L/min ozone, and the additive was 10 mg/L β-phenol; The control distance between the electrode was 85 mm, the tank voltage was 3.1V, the current density was 240 A/m², the electrolyte temperature was 45° C., the cycle speed was 15 L/min, and the electrolysis was carried out. When the residual electrode rate of the anode is about 15%, stop the power, take out the anode and cathode, and recover the anode and cathode products by ultrasonic method; The product enters the subsequent process, and the residue returns to the anode preparation process.

Embodiment 13: An electrochemical metallurgical process for extracting metals and sulfur from metal sulfides, the steps are as follows:
The copper matte of the present embodiment is a raw material of a copper smelter in Yunnan Province. Its chemical composition is shown in Table 5:
Table 5 Chemical Composition Mass fraction (%) of a copper matte in a copper smelter in Yunnan
(1) The anode was prepared by hot plating method: the copper matte was added to the induction furnace to heat and melt, and the base plate was inserted into the melt for hot plating. The base plate was made of conductive fiber, the longitudinal section shape was porous, the longitudinal section area was 0.35 m², the thickness was 3 mm, and there were 20 mm thick copper matte on both sides of the base plate;
The cathode material is stainless steel, the longitudinal section shape is square, the longitudinal section area is 0.4 m², the thickness is 2 mm;
(2) Take 135 pieces of anode, 136 pieces of cathode, anode and cathode spacing into the electrolyte,
Electrolyte with water as solvent, electrolyte is 50 g/L copper sulfate, 100 g/L sulfuric acid and 40 g/L sodium chloride, oxidant is 45 g/L iron sulfate, additive is 15 mg/L bone glue, 10 mg/L thiourea and 15 mg/L casein; The control distance between the electrode is 35 mm, the tank voltage is 3.2V, the current density is 240 A/m², the electrolyte temperature is 55° C., the cycle speed is 25 L/min, and the electrolysis is carried out. When the anode residue rate is about 10%, stop the power, take out the anode and cathode, recover the anode and cathode products by artificial method, the products enter the subsequent process, the anode and cathode return to the anode preparation process.

The cyclic voltammetry curve of the matte in the above electrolyte is shown in FIG. 2. As shown in the figure, there is an obvious oxidation peak near 3.2V, corresponding to the oxidation of sulfur in the matte; It can be seen that the method of electrochemical metallurgy to extract metal and sulfur from metal sulfide is theoretically feasible; The morphology of cathode product copper under scanning electron microscope is shown in FIG. 3, and the corresponding chemical composition of cathode product copper is shown in Table 6.

Table 6 Chemical composition of cathode product copper (%)

Raman diagram of anode product sulfur is shown in FIG. 4 and XRD diagram is shown in FIG. 5. The corresponding chemical composition of anode product sulfur is shown in Table 7.

Table 7 Sulfur chemical composition of anode product (%)

As can be seen from the above chart, the purity of both copper and sulfur is high, which shows that the electrochemical metallurgy method of extracting metals and sulfur from metal sulfides can be applied to practical production.

Example 14: An electrochemical metallurgical method for extracting metals and sulfur from metal sulfides, the steps are as follows:
(1) The copper matte and 5% of the mass of the copper matte are heated and melted in a reflector furnace, and the liquid copper matte is cast into a anode plate by sand casting method. The size after preparation is 1000 mm long, 500 mm wide and 50 mm thick;
The cathode material is copper, the longitudinal section shape is square, the longitudinal section area is 0.5 m², the thickness is 5 mm;
(2) Take 45 pieces of anode, 46 pieces of cathode, anode and cathode spacing into the electrolyte,
The electrolyte is water as solvent, the electrolyte is 45 g/L copper chloride and 180 g/L hydrochloric acid, the oxidant is 0.1 L/min oxygen, and the additive is 30 mg/L gelatin and 8 mg/L thiourea; The control distance between the electrode is 90 mm, the tank voltage is 3.5V, the current density is 280 A/m², the electrolyte temperature is 60° C., the cycle speed is 30 L/min, and the electrolysis is energized; When the residual electrode rate of the anode is about 20%, stop the power, take out the anode and cathode, and recover the anode and cathode products by mechanical method; The product enters the subsequent process, and the residue returns to the anode preparation process.

The embodiments of the invention are described in detail above, but the invention is not limited to the embodiments above, and various changes can be made within the scope of knowledge possessed by ordinary technicians in the field without deviating from the purpose of the invention.

The beneficial effects of the invention are:

(1) The metal sulfide electrode undergoes electrolysis in the electrolyte to extract cathode metal and anode sulfur, facilitating metal and sulfur extraction while reducing harmful gas emissions such as sulfur dioxide, thereby alleviating environmental pressure, decreasing sulfur import volume, and offering advantages such as a streamlined process, lower investment, and absence of sulfur dioxide pollution.

(2) Adjusting the semiconductor type of the metal sulfide electrode to P-type prevents the occurrence of the current “self-limiting effect” during anode electrolysis, ensuring smoother and more efficient electrochemical reactions.

(3) In the preparation process of the metal sulfide electrode, adding an adjusting element to enhance conductivity helps the electrode achieve higher current densities at lower tank voltages during anode electrolysis, enhancing overall electrolysis efficiency.

(4) By incorporating a reinforcing agent in the preparation process of the metal sulfide electrode, the mechanical properties of the electrode are improved. This reduces the residual electrode rate and labor intensity during production, contributing to more efficient and manageable electrode handling.

### BRIEF DESCRIPTION OF THE DRAWINGS

In order to more clearly illustrate technical solutions of embodiments of the invention or the prior art, drawings will be used in the description of embodiments or the prior art will be given a brief description below. Apparently, the drawings in the following description only are some of embodiments of the invention, the ordinary skill in the art can obtain other drawings according to these illustrated drawings without creative effort.

FIG. 1 shows the typical polarization curves of N-type semiconductors and P-type semiconductors;

FIG. 2 shows the cyclic voltammetry curve of embodiment 13 metal sulfide in electrolyte;

FIG. 3 shows the morphology of cathode product copper in Embodiment 13 under scanning electron microscope;

FIG. 4 is the Raman diagram of anode product of Embodiment 13 copper;

FIG. 5 is the XRD pattern of anode product sulfur in Embodiment 13.

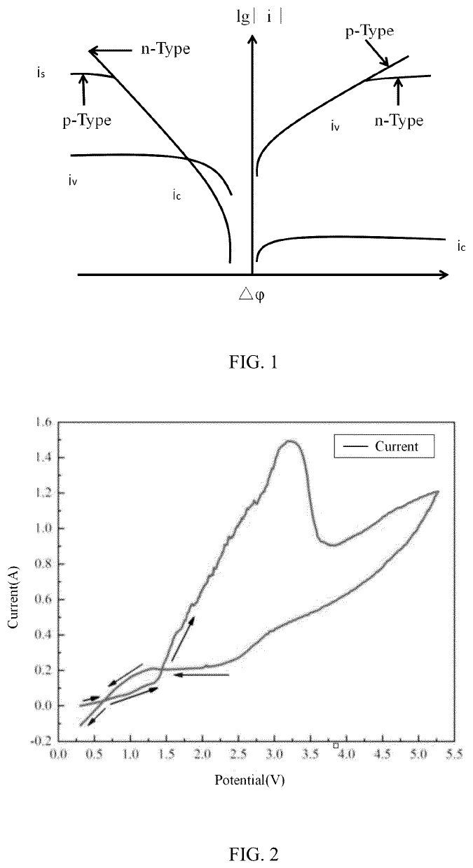

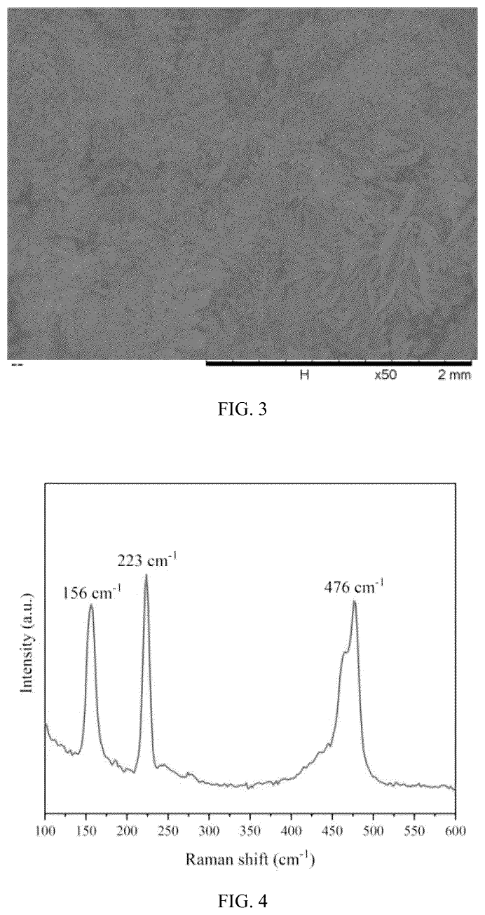

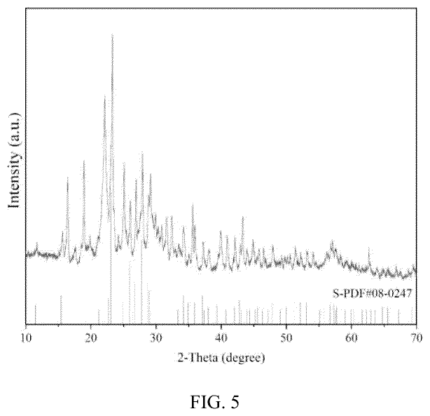

A method for improving liquid crystal rotation obstacle according to the first embodiment of the invention specifically includes steps as follows.

Step one: The metal sulfide is transformed into an electrode, referred to as a metal sulfide electrode. Throughout the preparation process, the composition of the metal sulfide can be tailored by incorporating additional elements, while the mechanical properties can be enhanced by introducing reinforcing agents. Potential elements that can be added include copper, manganese, cobalt, sulfur, molybdenum, tin, bismuth, lead, zinc, selenium, antimony, tellurium, and cadmium. The mass of the added element ranges from 0% to 50% of the mass of the metal sulfide. Additionally, reinforcing agents such as carbon fiber, stainless steel fiber, copper fiber, or lead fiber can be introduced, with the mass of the reinforcing agent ranging from 0% to 10% of the mass of the metal sulfide.

Preferably, the additive element is one or more kinds of copper, sulfur, tin, and the additive element mass is 5% to 15% of the mass of metal sulfide;

Preferably, the reinforcing agent is carbon fiber or stainless steel fiber, and the reinforcing agent quality is 0.5%˜1% of the quality of metal sulfide;

Metal sulfide primarily behaves as a semiconductor, with N-type semiconductor characteristics when used as the anode. However, its conductivity at the anode is often limited due to intrinsic properties. To facilitate smooth electrolysis at the anode, adjustments are made to its composition to transform it into a P-type semiconductor. When utilizing natural sulfide concentrates, metallurgical intermediates, or by-products as the anode, their high impurity content and poor electrical conductivity pose challenges. To ensure smooth electrolysis, the content of elements within them is adjusted to enhance their electrical conductivity. Moreover, metal sulfides tend to be brittle, leading to electrode breakage during the electrolytic process. Adjustments are made to the elemental proportions or additional materials, such as carbon fiber, are incorporated during the preparation process to augment its mechanical strength.

Step two: The metal sulfide electrode anode, along with the anode and cathode, is placed into the electrolyte to establish an electrode array. Parameters such as the distance between electrodes, tank voltage, current density, electrolyte temperature, and cycling speed are adjusted for the electrolysis process. During this process, the sulfur element within the metal sulfide is oxidized and adsorbed in elemental sulfur form at the anode, while metal ions migrate into the electrolyte. Reduction reactions occur on the surface of the cathode, resulting in the production of pure metal substances. The products from the anode and cathode are then stripped. The cathode materials may include titanium, copper, stainless steel, lead, zinc, aluminum, or graphite. The vertical section shape of the cathode corresponds to that of the anode, while the longitudinal section shape may vary, such as square, round, triangle, trapezoid, pentagon, or fan. The longitudinal section area of the cathode typically ranges from 1 cm² to 10 m². The thickness or radius of the cathode ranges from 0.2 mm to 3000 mm.

Parameters such as the distance between electrodes, tank voltage, current density, electrolyte temperature, and cycling speed are adjusted for the electrolysis process. During this process, the sulfur element within the metal sulfide is oxidized and adsorbed in elemental sulfur form at the anode, while metal ions migrate into the electrolyte. Reduction reactions occur on the surface of the cathode, resulting in the production of pure metal substances. The products from the anode and cathode are then stripped. The cathode materials may include titanium, copper, stainless steel, lead, zinc, aluminum, or graphite. The vertical section shape of the cathode corresponds to that of the anode, while the longitudinal section shape may vary, such as square, round, triangle, trapezoid, pentagon, or fan. The longitudinal section area of the cathode typically ranges from 1 cm² to 10 m². The thickness or radius of the cathode ranges from 0.2 mm to 3000 mm.

Preferably, the cathode is titanium, copper, stainless steel, lead or aluminum, the longitudinal section shape is square, the longitudinal section area is 200 cm²˜0.6 m², the thickness of the cathode is 1.5˜6 mm;

The number n of the anode ranges from 1 to 1000, and the number of cathodes is n+1; Preferably, the number of anodes n ranges from 35 to 350;

The metal sulfide can exist in a pure form or as a mixture, encompassing various compounds such as lithium sulfide, sodium sulfide, magnesium sulfide, aluminum sulfide, potassium sulfide, calcium sulfide, manganese sulfide, iron sulfide, ferrous sulfide, cobalt sulfide, copper sulfide, cuprous sulfide, zinc sulfide, molybdenum sulfide, silver sulfide, cadmium sulfide, tin sulfide, antimony sulfide, lead sulfide, and bismuth sulfide. Mixtures of metal sulfides may include natural sulfide concentrates, metallurgical intermediate products, or by-products. Examples of natural sulfide concentrates comprise, but are not limited to, pyrite, green vanadite, chalcopyrite, bornite, chalcocite, cuprite, fahlerite, arsenophenite, cobaltite, quartzite, wolframite, sulfotin, tetrahedrite, columnite, sulfotinite, antiantimonite, disulfide tin, trapezite, manganese sulfite, and pyroxene. Additionally, metallurgical intermediate products or by-products may include copper matte, cobalt matte, lead matte, antimony matte, iron matte, copper matte, and bismuth matte.

Preferably, metal sulfides: sodium sulfide, tin sulfide, aluminum sulfide, antimony sulfide, bismuthite, manganese sulfide, sphalerite, galena, copper matte.

The preparation of the metal sulfide electrode can be accomplished through various methods, including the thermal spraying method, hot plating method, physical vapor deposition method, chemical vapor deposition method, casting method, or powder metallurgy method. Specifically, the physical vapor deposition method encompasses techniques such as vacuum evaporation method and magnetron sputtering method, while the casting method includes approaches like sand casting method and solid casting method. Additionally, the powder metallurgy method involves techniques like the press method and centrifugal forming method.

Preferably, the thermal spraying method involves melting the metal sulfide powder using a heat source and forming the metal sulfide electrode on the substrate's surface by controlling the pressure of the protective gas. The pressure typically ranges from 1 to 20 MPa. Plasma arc heating is a preferred heat source, and the pressure is preferably maintained between 5 to 15 MPa for optimal results.

In the vacuum evaporation method, the metal sulfide powder is introduced into the evaporation container, and the vacuum is adjusted. The powder is then heated to deposit metal sulfide electrodes onto the substrate. The vacuum level typically ranges from 10⁻⁶ to 10² Pa. Resistance heating is the preferred heating method for this process.

In the magnetron sputtering method, the substrate is connected to the anode, while the metal sulfide target is connected to the cathode. The vacuum is pumped below 10⁻³ Pa, and argon gas is introduced to maintain the vacuum within the range of 10⁻² to 10 Pa. Power is then applied to obtain metal sulfide electrodes through magnetron sputtering. The material of the sulfide target may include magnesium sulfide, zinc sulfide, calcium sulfide, aluminum sulfide, or cadmium sulfide, with aluminum sulfide being preferred.

In the chemical vapor deposition method, a protective gas is filled in the chemical vapor deposition setting. Metal powder and sulfur powder are placed in the evaporator and heated to evaporate into the reaction chamber, where they react and deposit on the substrate to form the metal sulfide electrode. Argon gas is preferred as the protective gas in this method.

The hot plating method involves melting the metal sulfide in a melting furnace, and the substrate is then immersed in the liquid metal sulfide for hot plating to produce the metal sulfide electrode.

In the sand casting method, a cavity is prepared using mold sand and core sand. The molten metal sulfide is poured into the cavity from a melting furnace, followed by cooling and solidification. The metal sulfide electrode is obtained through sand cleaning.

Similarly, in the solid casting method, foam is buried in sand, and the metal sulfide is melted in a furnace. The molten metal sulfide replaces the foam, and upon cooling and solidification, the metal sulfide electrode is obtained by removing the sand.

When employing the hot plating method, sand casting method, or solid casting method, it is preferable to use a vacuum induction furnace, vacuum arc furnace, induction furnace, or reverberatory furnace.

In the press method, metal sulfide powder and forming agent are mixed evenly into a mold, pressed to form a green body, and then sintered to obtain the metal sulfide electrode. The pressing molding pressure typically ranges from 10 to 30 MPa, with a pressing speed of 1 to 15 mm/s and a pressure holding time of 0.1 to 10 hours. Preferred parameters include a pressure of 20 to 25 MPa, a pressing speed of 10 to 12 mm/s, and a holding time of 1.5 to 2 hours.

In the centrifugal forming method, the metal sulfide powder and forming agent are uniformly mixed and placed into a mold. Centrifugal force is then applied to the mold to achieve shaping, resulting in a green body. This green body is subsequently sintered to obtain the metal sulfide electrode. The centrifugal forming speed typically ranges from 500 to 4500 revolutions per minute (r/min), with preferred speeds falling between 3000 and 3500 r/min.

During sintering, the atmosphere is maintained as a protective gas environment. The sintering temperature typically ranges from 400 to 1200 degrees Celsius (° C.), with preferred temperatures falling between 750 and 1200° C. The duration of sintering ranges from 0.1 to 10 hours, with preferred sintering times being 1.5 to 2 hours.

Protective gases include but are not limited to argon, nitrogen, carbon dioxide;

The average particle size of the metal sulfide powder is 1 nm˜1 mm.

The substrate material for the metal sulfide electrode can be chosen from metals, graphite, or composite materials. For metal substrates, options include but are not limited to copper, zinc, lead, tin, aluminum, titanium, stainless steel, aluminum alloy, lead alloy, titanium alloy, manganese alloy, copper alloy, zinc alloy, tin alloy, tungsten alloy, and molybdenum alloy. Composite substrates can include conductive materials such as conductive silicone rubber, conductive plastic, and conductive fiber. Preferred substrate materials include titanium, stainless steel, titanium alloy, lead alloy, or conductive fiber due to their suitability for electrochemical processes and their ability to withstand harsh conditions during electrolysis.

The substrate can feature various longitudinal section shapes such as square, circular, triangular, palisade, or porous. Its longitudinal section area typically ranges from 1 cm² to 10 m². with a thickness or radius of 1 mm to 2000 mm. The adhesion thickness of the metal sulfide on the substrate usually falls between 1 mm to 30 mm.

Preferred longitudinal section shapes for the substrate include square, circular, triangular, palisade, or porous, with a longitudinal section area preferably ranging from 180 cm² to 0.35 m² and a thickness or radius ranging from 1 mm to 3 mm. The adhesion thickness of the metal sulfide on the substrate is preferably 3 mm to 20 mm.

For metal sulfide electrodes prepared by casting or powder metallurgy methods, they typically take the shape of a cuboid with two ears. The length can range from 100 mm to 2500 mm, the width from 100 mm to 2000 mm, and the thickness from 1 mm to 100 mm. Preferably, the length is between 800 mm to 1200 mm, the width is between 500 mm to 700 mm, and the thickness is between 45 mm to 60 mm.

Forming agents used in the process include but are not limited to starch, sulfur, molybdenum disulfide, graphite powder, paraffin wax, and rosin. Among these, sulfur or graphite powder is preferred.

The electrolyte contains a solvent, electrolyte, oxidizer, additive, the solvent is water or organic solvent, organic solvent is anhydrous acetic acid, methanol, acetonitrile, tetrahydrofuran one or more; Preferably, the organic solvent is one or more of methanol, acetonitrile, tetrahydrofuran;

The electrolytes used in the process include sulfuric acid, perchloric acid, hydrobromic acid, hydrochloric acid, silofluoric acid, carbonic acid, phosphoric acid, nitrite, hydroiodic acid, tartaric acid, oxalic acid, citric acid, hydrofluoric acid, acetic acid, hypochloric acid, boric acid, bismuth chloride, bismuth sulfate, bismuth fluorosilicate, sodium chloride, lithium perchlorate, magnesium perchlorate, molybdenum chloride, sodium sulfate, aluminum chloride, sodium nitrate, molybdenum sulfate, copper chloride, copper sulfate, lead chloride, lead fluosilicate, cadmium chloride, antimony chloride, silver nitrate, stannous sulfate, zinc chloride, sodium acetate, sodium nitrite, sodium borate, zinc sulfate, manganese chloride, cobalt chloride, ammonium sulfate, cobalt sulfate, sodium oxalate, sodium tetrafluoroborate, sodium sulfide, sodium hydroxide, calcium sulfonate, potassium methanol, aluminum stearate, ammonium chloride, tetraethyl tetrafluoroborate, and ammonium tetrafluoroborate. The concentration of the electrolyte in the solution typically ranges from 0.1 g/L to 1000 g/L.

Preferably, the electrolyte comprises one or more of sulfuric acid, hydrochloric acid, silicofluoric acid, sodium tetrafluoroborate, sodium chloride, stannous sulfate, aluminum chloride, ammonium chloride, sodium sulfide, sodium hydroxide, bismuth chloride, bismuth silicofluorate, manganese chloride, ammonium sulfate, zinc sulfate, zinc chloride, lead chloride, lead fluorosilicate, copper sulfate, and copper chloride. The concentration of the electrolyte typically ranges from 10 g/L to 240 g/L.

As for the oxidizer, it can be ferric chloride, potassium permanganate, oxygen, hydrogen peroxide, fluorine, ozone, ferric sulfate, chlorine, bromine vapor, sodium dichromate, or a combination thereof. The oxidizer can either be in gas form or non-gas form, with a flow rate of 0.01 L/min to 5 L/min for gas and a concentration of 0.1 g/L to 1000 g/L for non-gas oxidizers.

Preferably, the oxidizer includes sodium perchlorate, ferric chloride, potassium permanganate, oxygen, hydrogen peroxide, ferric sulfate, or sodium hypochlorite. When using oxygen as the oxidizer, the flow rate ranges from 0.1 L/min to 0.15 L/min, and when using a non-gas oxidizer, the concentration in the electrolyte ranges from 10 g/L to 45 g/L.

Additionally, additives such as gelatin, bone glue, leather glue, thiourea, β-phenol, powder glue, sodium lignosulfonate, carbolic acid, tannin, diphenylamine, phenol, or borax can be used. The content of additives in the electrolyte ranges from 0 g/L to 1000 g/L. If the additive content is 0, then the electrolyte does not contain any additives.

Preferably, the additive is gelatin, bone glue, thiourea, β-phenol, cresol sulfonic acid, sodium lignosulfonate, casein one or more.

When the electrolyte contains additives, the preferred content of additives is 8˜30 mg/L;

The distance between the same plate is 1˜1000 mm, the tank voltage range is 0.1˜10V, the current density control range is 1˜1000 A/m², the electrolyte temperature range is 25˜100° C., the cycle speed range is 1˜100 L/min, the anode residue rate is 1%˜ 25%;

Preferably, the distance between the same plate is 18˜120 mm, the tank voltage range is 1.5˜3.5V, the current density control range is 150˜450 A/m², the electrolyte temperature range is 25˜60° C., the cycle speed range is 5˜30 L/min, the anode residue rate is 5%˜20%;

The method of stripping the product is ultrasonic method, mechanical method or manual method.

The principle of extracting metals and sulfur from metal sulfides relies on semiconductor electrochemistry. From a physical perspective, semiconductor behavior determines the electrochemical reactions occurring at the electrode interfaces. In semiconductor electrochemistry, when a semiconductor is of N-type, the charge carriers are free electrons. When the cathode is polarized, the abundance of free electrons in the conduction band increases, facilitating reaction occurrence. However, when the anode is polarized in an N-type semiconductor, few subsequent holes in the valence band participate in the reaction at the semiconductor/electrolyte interface. Instead, many subsequent electrons in the conduction band are repelled and flow away from the interface. As polarization increases, the rate (ic) of electrons participating in the cathode reaction increases. However, the electron concentration at the semiconductor/electrolyte interface can become even lower than the hole concentration. This phenomenon leads to a “self-limiting effect” on the current, where the current reaches a saturated value (is). Therefore, in electrolysis involving semiconductor anodes, N-type semiconductors are not suitable due to this self-limiting effect. Conversely, when cathode polarization occurs in the valence band of P-type semiconductors, a similar self-limiting effect and saturation current can be observed. However, when a P-type semiconductor electrode is oxidized, there is no self-limiting effect, allowing smooth anodic polarization reaction in the valence band. Hence, in the electrolytic process, P-type semiconductors are more suitable for use as anodes.

The typical polarization curves of N-type and P-type semiconductors illustrate these behaviors. In FIG. 1, iv indicates the rate at which holes in the valence band participate in the electrode reaction.

From a chemical point of view, when oxidizing agents (such as hydrogen peroxide) are higher than S²⁻ in metal sulfide (Me₂Sx), the oxidizing agent can oxidize S²⁻ to sulfur, the relevant reaction equation is (1); At the same time, when the metal sulfide is an anode, a positive voltage is applied, and the anode oxidizes, and the relevant reaction equation is (2); The sulfur element in the metal sulfide is oxidized and adsorbed on the anode plate in the form of sulfur element. As the sulfur element is oxidized, the metal ions enter the electrolyte, and the reduction reaction occurs on the cathode surface to form the metal. The relevant reaction equation is shown in (3).

Me₂Sₓ+xH₂O₂+2xH+→2Mex++xS+2xH₂O (1)

Me₂Sx-2xe−→2Mex++xS (2)

Mex++xe−→Me (3)

What is claimed is:

1. An electrochemical metallurgical process for extracting metals and sulfur from metal sulfides, characterized by the following steps:
(1) Metal sulfide is transformed into an electrode, known as a metal sulfide electrode;
(2) The metal sulfide electrode serves as the anode, alongside the insertion of both anode and cathode into the electrolyte at intervals to establish an electrode array for electrolysis, during this process, the sulfur element within the metal sulfide undergoes oxidation and is absorbed in the form of sulfur onto the anode, simultaneously, metal ions migrate into the electrolyte, initiating reduction reactions on the cathode surface, resulting in the formation of metal elements, cathode materials may include titanium, copper, stainless steel, lead, zinc, aluminum, or graphite.

2. According to the electrochemical metallurgical method for extracting metal and sulfur from metal sulfide as described in claim 1, it is distinguished by the adjustment of metal sulfide composition through the addition of elements during the preparation phase, as well as the modification of mechanical properties by incorporating enhancers, these additional elements may include one or more of copper, manganese, cobalt, sulfur, molybdenum, tin, bismuth, lead, zinc, selenium, antimony, tellurium, cadmium, and the reinforcing agent is carbon fiber, stainless steel fiber, copper fiber or lead fiber;
Metal sulfide can exist as a pure substance or a mixture, pure substances encompass various compounds, including but not limited to lithium sulfide, sodium sulfide, magnesium sulfide, aluminum sulfide, potassium sulfide, calcium sulfide, manganese sulfide, iron sulfide, ferrous sulfide, cobalt sulfide, copper sulfide, cuprous sulfide, zinc sulfide, molybdenum sulfide, silver sulfide, cadmium sulfide, tin sulfide, antimony sulfide, lead sulfide, and bismuth sulfide;
Mixtures of metal sulfides include natural sulfide concentrates, metallurgical intermediates, or by-products, examples of natural sulfide concentrates consist of, but are not limited to, pyrite, green vanadite, chalcopyrite, bornite, chalcocite, cuprite, fahlerite, arsenophenite, cobaltite, quartzite, wolframite, sulfotin, tetrahedrite, columnite, sulfotinite, antiantimonite, disulfide tin, trapezite, manganese sulfite, and pyroxene. Additionally, mixtures may comprise metallurgical intermediates or by-products such as copper matte, cobalt matte, lead matte, antimony matte, iron matte, copper matte, and bismuth matte.

3. Claim 2's electrochemical metallurgical method for extracting metals and sulfur from metal sulfides is characterized by employing various preparation methods for metal sulfide electrodes, these methods include thermal spraying, hot plating, physical vapor deposition (such as vacuum evaporation and magnetron sputtering), chemical vapor deposition, casting (such as sand casting and solid casting), and powder metallurgy (such as pressing and centrifugal forming).

4. Electrochemical metallurgical method for extracting metals and sulfur from metal sulfides in accordance with claim 3, characterized by:
Thermal spraying method: the use of heat sources to melt the metal sulfide powder, by controlling the pressure of the protective gas is sprayed to the surface of the substrate to form a metal sulfide electrode, where the pressure is 1˜20 MPa;
Vacuum evaporation method: the metal sulfide powder is added to the evaporation container, adjust the vacuum degree, heating the powder deposited on the substrate to obtain the metal sulfide electrode, where the vacuum degree is 10⁻⁶˜10² Pa;
In the magnetron sputtering method, the substrate is linked to the anode while the metal sulfide target is connected to the cathode, the vacuum is reduced to below 10⁻³ Pa, followed by filling with argon to maintain the vacuum within the range of 10⁻² to 10 Pa, power is then activated, leading to the deposition of the metal sulfide electrode through magnetron sputtering; The material composition of the sulfide target encompasses, but is not restricted to, magnesium sulfide, zinc sulfide, calcium sulfide, aluminum sulfide, and cadmium sulfide;
In the chemical vapor deposition method, the metal powder and sulfur powder are placed in an evaporator within a chemical vapor deposition chamber filled with protective gas, upon heating, the metal and sulfur powders evaporate and react in the chamber, depositing onto the substrate and forming the metal sulfide electrode;
In the hot plating method, the metal sulfide is melted within a melting furnace, and the substrate is immersed into the molten metal sulfide for hot plating, resulting in the formation of the metal sulfide electrode;
The sand casting method involves preparing a cavity using mold sand and core sand, the metal sulfide is melted in a furnace, poured into the prepared cavity, and left to cool and solidify, the metal sulfide electrode is obtained through sand removal and cleaning;
For the solid casting method, foam is buried in sand, and the metal sulfide is melted in a furnace, the molten metal sulfide replaces the foam, and upon cooling and solidification, the metal sulfide electrode is obtained through sand removal and cleaning;
In the press method, metal sulfide powder and forming agent are mixed and pressed into a mold to obtain a green form, the green form is then sintered to obtain the metal sulfide electrode, pressing parameters include a molding pressure of 10 to 30 MPa, pressing speed of 1 to 15 mm/s, and pressure holding time of 0.1 to 10 hours;
Similarly, in the centrifugal forming method, metal sulfide powder and forming agent are mixed and centrifugally formed in a mold to obtain a green form, the green form is then sintered to obtain the metal sulfide electrode, centrifugal forming speed typically ranges from 500 to 4500 r/min;
Sintering is typically conducted in a protective gas atmosphere, with temperatures ranging from 400 to 1200° C. and sintering times from 0.1 to 10 hours, protective gases used include but are not limited to argon, nitrogen, and carbon dioxide.

5. Claim 4's electrochemical metallurgical method for extracting metals and sulfur from metal sulfides is distinguished by the average particle size of the metal sulfide powder, which ranges from 1 nm to 1 mm.

6. In accordance with claim 4, the electrochemical metallurgical method for extracting metals and sulfur from metal sulfides is characterized by the substrate material, which can be metal, graphite, or composite material: Metal substrate materials include, but are not limited to, copper, zinc, lead, tin, aluminum, titanium, stainless steel, aluminum alloy, lead alloy, titanium alloy, manganese alloy, copper alloy, zinc alloy, tin alloy, tungsten alloy, and molybdenum alloy, composite substrate materials include, but are not limited to, conductive silicone rubber, conductive plastic, and conductive fiber.

7. As per claim 4, the electrochemical metallurgical method for extracting metals and sulfur from metal sulfides is distinguished by the dimensions of the substrate: The longitudinal cross-section area ranges from 1 cm² to 10 m², while the thickness or radius ranges from 1 to 2000 mm, additionally, the adhesion thickness of metal sulfide on the substrate ranges from 1 to 30 mm.

8. According to claim 4, the electrochemical metallurgical method for extracting metals and sulfur from metal sulfides is characterized by the forming agent, which includes but is not limited to starch, sulfur, molybdenum disulfide, graphite powder, paraffin wax, and rosin.

9. The electrochemical metallurgical method for extracting metals and sulfur from metal sulfides described in claim 1 is characterized by the composition of the electrolyte, which contains solvents, electrolytes, oxidants, and additives, the solvent can be water or an organic solvent, where the organic solvent includes one or more of anhydrous acetic acid, methanol, acetonitrile, and tetrahydrofuran;
The electrolyte utilized in the electrochemical metallurgical method for extracting metals and sulfur from metal sulfides, as described in claim 1, includes sulfuric acid, perchloric acid, hydrobromic acid, hydrochloric acid, silofluoric acid, carbonic acid, phosphoric acid, nitrite, hydroiodic acid, tartaric acid, oxalic acid, citric acid, hydrofluoric acid, acetic acid, hypochloric acid, boric acid, bismuth chloride, bismuth sulfate, bismuth fluorosilicate, sodium chloride, lithium perchlorate, magnesium perchlorate, molybdenum chloride, sodium sulfate, aluminum chloride, sodium nitrate, molybdenum sulfate, copper chloride, copper sulfate, lead chloride, lead fluosilicate, cadmium chloride, antimony chloride, silver nitrate, stannous sulfate, zinc chloride, sodium acetate, sodium nitrite, sodium borate, zinc sulfate, manganese chloride, cobalt chloride, ammonium sulfate, cobalt sulfate, sodium oxalate, sodium tetrafluoroborate, sodium sulfide, sodium hydroxide, calcium sulfonate, potassium methanol, aluminum stearate, ammonium chloride, tetraethyl tetrafluoroborate, and ammonium tetrafluoroborate; The content of the electrolyte in the solution ranges from 0.1 to 1000 g/L;
The oxidizer employed in the process includes ferric chloride, potassium permanganate, oxygen, hydrogen peroxide, fluorine, ozone, ferric sulfate, chlorine, bromine vapor, sodium dichromate, either singly or in combination, when the oxidizer is a gas, the flow rate ranges from 0.01 to 5 L/min; when it is not a gas, the content of the oxidizer in the electrolyte ranges from 0.1 to 1000 g/L;
Various additives are incorporated into the electrolyte, such as gelatin, bone glue, leather glue, thiourea, β-phenol, powder glue, sodium lignosulfonate, carbolic acid, tannin, diphenylamine, phenol, borax, and casein, The content of additives in the electrolyte ranges from 0 to 1000 g/L.

10. The electrochemical metallurgical method for extracting metals and sulfur from metal sulfides, in accordance with claim 1, is characterized by specific operational parameters: The distance between the plates ranges from 1 to 1000 mm, the voltage applied to the tank ranges from 0.1 to 10 V, the control range of current density is 1 to 1000 A/m², the temperature of the electrolyte ranges from 25 to 100° C., the circulation speed ranges from 1 to 100 L/min, and the anode residue rate ranges from 1% to 25%.
